(19) United States
(12) Patent Application Publication
(10) Pub. No.: US 2016/0047522 A1
(43) Pub. Date: Feb. 18, 2016

(54) LIGHTING DEVICE

(71) Applicant: KONINKLIJKE PHILIPS N.V., Eindhoven (NL)

(72) Inventors: JOHANNNES WILHELMUS WEEKAMP, BEEK EN DONK (NL); GIOVANNI CENNINI, EINDHOVEN (NL); SEBASTIEN PAUL RENE LIBON, TERVUREN (BE)

(21) Appl. No.: 14/779,802

(22) PCT Filed: Mar. 18, 2014
(86) PCT No.: PCT/IB2014/059920

§ 371 Date: Sep. 24, 2015

(30) Foreign Application Priority Data
Mar. 26, 2013 (EP) 13161000.8

(51) Int. Cl. F21V 1/14; F21V 7/18; F21V 17/00; F21V 7/00

(52) U.S. Cl. CPC F21V 1/146; F21V 7/0008; F21V 7/18; F21V 17/007; F21Y 2101/02

(57) ABSTRACT

A lighting device (1) comprising a support panel (2) located between two outer sheets (8, 10), which support panel is provided with at least one light emitting module (3), whilst at least one of the outer sheets (10) is translucent. The outer sheets are movable with respect to each other at least from a folded position in which the support panel and the outer sheets extend substantially parallel to each other and an unfolded position in which the outer sheets are at least partly further spaced apart than in the folded position. One of the outer sheets (8) is reflective, wherein, in the unfolded position of the lighting device, light emitted by the light emitting module towards the reflective outer sheet is reflected by the reflective outer sheet towards the translucent outer sheet through the support panel.

### FIELD OF THE INVENTION

The invention relates to a lighting device comprising a support panel located between two outer sheets, which support panel is provided with at least one light emitting module, whilst at least one of the outer sheets is translucent, which outer sheets are movable with respect to each other at least from a folded position wherein the support panel and the outer sheets extend substantially parallel to each other and an unfolded position in which the outer sheets are at least partly further spaced apart than in the folded position.

### BACKGROUND OF THE INVENTION

Foldable lighting devices are in very widespread use in a multitude of fields.

WO2009/147657A2 shows a foldable lampshade adaptable for inexpensive mass production and configured for easy assembly. The frame part comprises a pair of connected or separate complementary sheet like parts, each being substantially shaped as a mirror image of the other. The sheet-like part is a sheet or foil, optionally having concave and/or convex relief shapes and/or notched curves as ornaments or folding aids. The lamp shade may be assembled and disassembled without removing the lamp socket with the lamp bulb.

It is a disadvantage of this lighting device that a user of the lighting device will experience so-called glare when looking towards the lighting device.

### SUMMARY OF THE INVENTION

In view of the above-mentioned and other drawbacks of the prior art, a general object of the present invention is to provide an improved foldable lighting device and in particular a lighting device that is easy to assemble and that reduces glare for a user of the lighting device to a great extent.

According to a first aspect, the invention provides a lighting device wherein one of the outer sheets is reflective, and in the unfolded position of the lighting device, light emitted by the light emitting module towards the reflective outer sheet is reflected by the reflective outer sheet towards the translucent outer sheet through the support panel.

The light emitting module can be any form of light emitting module, such as a conventional light bulb, a neon light or the like, but is preferably a light emitting diode (LED), that produces light having a very high intensity and that has a relative low power consumption compared to other light emitting modules. The light emitting modules are preferably mounted only on the side of the support panel facing the reflective outer sheet.

The reflective outer sheet has reflective properties in the direction facing the at least one light emitting module. Preferably, the reflective outer sheet is highly reflective to reflect light to the maximum. The reflective outer sheet can for example be a MCPET sheet or an aluminium sheet.

The translucent outer sheet is a sheet that allows the light to pass from the inside of the lighting device to the outside of the lighting device. The translucent outer sheet is mounted on the side of the support panel facing away from the at least one light emitting module. The translucent outer sheet can be a plastic sheet.

The support panel comprises the at least one light emitting module and can comprise also the electric power supply lines that are needed to supply the at least one light emitting module with electric power.

More than one light emitting module can be mounted on the support panel. To this end, an array of interconnected light emitting modules can be formed.

A light ray that is emitted by the at least one light emitting module will travel towards the reflective outer sheet. The reflective outer sheet will reflect the light ray through the support panel, in the direction of the translucent outer sheet and through the translucent outer sheet towards the outside of the lighting device.

When using for example LED's, the distance between the LED's on the support panel is preferably less than the distance between the LED's and the translucent outer sheet to obtain a uniform light distribution over the translucent outer sheet. Since the light is first directed towards the reflective outer sheet and then reflected back through the support panel towards the translucent outer sheet, the distance between the two outer sheets can be about ⅔ of the distance which would be needed if the light were directed directly from the support panel to the translucent outer sheet to obtain the same length of a light path. According to a further aspect, the invention provides a lighting device wherein the support panel is at least partly translucent.

Preferably, the support panel has an open structure, allowing light to pass through the support panel. The light that is reflected by the reflective outer sheet will pass through the support panel on which the light emitting modules and the electric power supply lines are mounted.

In order to minimize the amount of light that is blocked by the light emitting modules, the support panel itself and eventually the electric power supply lines, the support panel can comprise translucent parts, such as for example a base panel made out of a transparent plastic. Alternatively, the support panel can be formed as a wire grid onto which light emitting modules are mounted. The areas that are not covered with wires or light emitting modules can be open areas. No base panel has to be provided in those areas, as the constructional strength of the support panel can be provided by the wire grid.

According to a further aspect, the invention provides a lighting device wherein the translucent outer sheet is a light diffuser.

The light diffuser can be a translucent plastic sheet having a certain surface roughness. The surface roughness breaks up a light ray that passes through the light diffuser and disperses the light in multiple directions. The use of a diffuser has the advantage that light of relatively high intensity is spread out in multiple directions, thus reducing the relative intensity of the light in one specific direction. Glare, that is caused by high intensity light rays in a specific direction, is thus further reduced to a great extent.

When a light ray emitted by the light emitting module is reflected by the reflective outer sheet towards the support panel, the light ray may hit the light emitting module and thus cause a shadow on the translucent outer sheet. The diffuser as a translucent outer sheet will disperse the light and provide an even distribution of light to the user and thus compensate for the shadow. To this end, the diffuser needs to be spaced apart from the support panel.

The diffuser sheet is preferably a PET or PC film having a surface roughness.

According to a further aspect, the invention provides a lighting device wherein, in the unfolded position, the outer sheets are curved.

In the folded position of the lighting device, the outer sheets can have a width that is larger than the width of the support panel. In the unfolded position, the distance between the longitudinal sides of the outer sheets is smaller than in the folded position. This allows the outer sheets to be curved. The curvature of the outer sheets allows the outer sheets to be spaced apart, and thus allows the light to be better reflected on the reflective outer sheet or better diffused when passing through the translucent outer sheet that acts as a diffuser.

A curved reflective outer sheet allows the light to be reflected in different directions, as the incoming and outgoing angles of the light rays vary at each point of the curved reflective outer sheet. A curved translucent outer sheet as a diffuser provides the necessary space between the support panel and the diffuser sheet to prevent spotty shadows on the diffuser sheet.

According to a further aspect, the invention provides a lighting device wherein the reflective outer sheet is opaque.

An opaque reflective outer sheet prevents light from passing through the reflective outer sheet. As the reflective outer sheet reflects all the light that hits the reflective sheet, the loss of light is minimized and the light output through the translucent outer sheet is maximized.

According to a further aspect, the invention provides a lighting device wherein the outer sheets each have two parallel longitudinal sides, the parallel longitudinal sides of the reflective outer sheet and the respective parallel longitudinal sides of the translucent outer sheet being connectable to each other by fastening means.

The fastening means can comprise for example clips, rings or adhesive tape. Once connected, the fastening means allow tilting of a region near the longitudinal side of the translucent outer sheet with respect to a region near the longitudinal side of the reflective outer sheet to unfold the lighting device.

According to a further aspect, the invention provides a lighting device wherein, in the unfolded position, the interconnected parallel longitudinal sides of the outer sheets comprise a mount for the support panel.

In the unfolded position of the lighting device, the outer sheets can be curved in such a way that the connected parallel longitudinal sides of the outer sheets are at a distance with regard to each other that is approximately the same as the width of the support panel. The curved reflective outer sheet and the curved translucent outer sheet are mounted, at an angle with respect to each other, in the region of the connected parallel longitudinal sides. The support panel can then be held in place as a result of the respective angles formed by the two outer sheets on both parallel longitudinal sides. In the unfolded position of the lighting device, the support panel is stuck between the connected parallel longitudinal sides. In the ideal situation there will be no play between the support panel and the connected parallel longitudinal sides, so that the support panel is firmly held in place and is unable to move in directions parallel to the support panel.

The support panel can be fastened to either one of the outer sheets by means of the fastening means to prevent the support panel from moving in the longitudinal direction. In case that the support panel is fastened to either one of the outer sheets, the constructional integrity of the lighting device is guaranteed, as in the unfolded position of the lighting device the fastened support sheet prevents the curved outer sheets from returning to their folded position.

Alternatively, the connected parallel longitudinal sides can comprise protrusions, i.e. folded edges, that form a mount for the support panel.

According to a further aspect, the invention provides a lighting device wherein at least one of the outer sheets comprises a flap being foldable around a folding line that extends between the two parallel longitudinal sides.

The flap is foldable between a folded flat position and an unfolded position in which the flap is folded through a certain angle around the folding line, thus at least partly covering the transverse side of the lighting device.

According to a further aspect, the invention provides a lighting device wherein the folding line is arc-shaped, the convex side of the arc-shaped folding line being located outside the flap.

The arc-shaped folding line is advantageous when the outer sheets have a curved form in the unfolded position. When folding the flap over the arc-shaped folding line, the folding line will define the curvature of the outer sheet to which it is attached.

According to a further aspect, the invention provides a lighting device wherein the flap is delimited by the arc-shaped folding line on one side of the flap and an arc-shaped edge on the opposite side of the flap.

When the translucent outer sheet and the reflective outer sheet are curved, an opening on the transverse side of the lighting device will have a cross section that is curved on both sides of the outer sheets. The flap will be able to cover the entire opening.

The flap is preferably folded through approximately 90 degrees and extends therefore substantially perpendicularly to the support panel. The flap is curved in such a way that the arc-shaped edge of the flap of one outer sheet is adjacent to the curved edge of the other outer sheet.

According to a further aspect, the invention provides a lighting device wherein, in the unfolded position, the outer sheets are held spaced apart from each other by the folded flap.

In order for the translucent outer sheet and the reflective outer sheet to remain in a curved position, the folded flap provides a blocking means preventing the outer sheets to return to the folded position. To this end, the arc-shaped edge of the flap of one outer sheet is adjacent to the curved edge of the other outer sheet.

Preferably, both outer sheets are provided with flaps on both sides, wherein the flaps near one side of the two outer sheets extend parallel to each other, and wherein the arc-shaped folding line of one outer sheet is located near the arc-shaped edge of the other outer sheet.

The invention further relates to a lighting device comprising a support panel located between two outer sheets, which support panel is provided with at least one light emitting module, which outer sheets each have two parallel longitudinal sides, which outer sheets are movable with respect to each other at least from a folded position wherein the support panel and the outer sheets extend substantially parallel to each other and an unfolded position in which the outer sheets are at least partly further spaced apart than in the folded position.

According to an aspect of the invention, the lighting device is provided wherein, in the folded position, the two parallel longitudinal sides of a first of the two outer sheets are connected to the respective two parallel longitudinal sides of a second of the two outer sheets to form a first and second set of interconnected longitudinal sides, wherein the first and second sets of interconnected longitudinal sides are movable towards each other to space apart the outer sheets in the unfolded position.

For moving the lighting device from a folded to an unfolded position, the first and second set of interconnected longitudinal sides are moved towards each other. During this movement the two outer sheets will curve, allowing them to become at least partly spaced apart from the support panel. The result of the movement and curvature is a lighting device having a tube-like shape. In the folded position, the lighting device is relatively flat and therefore takes up very little space and is easy to store and transport.

According to a further aspect, the invention provides a lighting device wherein the two sets of interconnected longitudinal sides of the outer sheets comprise a mount for the support panel.

The mount can be provided by the two sets of interconnected longitudinal sides, as each set of interconnected longitudinal sides comprises two outer sheets that are mounted to each other by a fastening means. The two outer sheets tilt with respect to each other when two sets of interconnected longitudinal sides are moved towards each other. This causes the outer sheets to curve at the same time. The two curved outer sheets form an angle in the region of the set of interconnected longitudinal sides. The two sets of interconnected longitudinal sides are moveable towards each other until the longitudinal sides of the support panel prevent further movement and the support is mounted in the angular space formed by the interconnected longitudinal sides.

### BRIEF DESCRIPTION OF THE DRAWINGS

These and other aspects of the invention will now be described in more detail, with reference to the appended drawings showing currently preferred embodiments of the inventions, wherein:

FIGS. 1A and 1B show a perspective view and a cross sectional view, respectively, of a first embodiment of the lighting device according to the invention in the unfolded position;

FIGS. 2A and 2B show a perspective view and a cross sectional view, respectively, of the embodiment as shown in the FIGS. 1A and 1B in the folded position;

FIGS. 3A and 3B show a perspective view and a cross sectional view, respectively, of a stack of layers of the lighting device as shown in FIGS. 2A and 2B in the folded position;

FIG. 4 shows a cross sectional view of a second embodiment of the lighting device according to the invention;

FIG. 5A shows a perspective view of a third embodiment of the lighting device according to the invention in the unfolded position; and

FIG. 5B shows a plano view of the outer sheets and the flaps of the lighting device as shown in FIG. 5A in a folded position.

### DESCRIPTION OF PREFERRED EMBODIMENTS

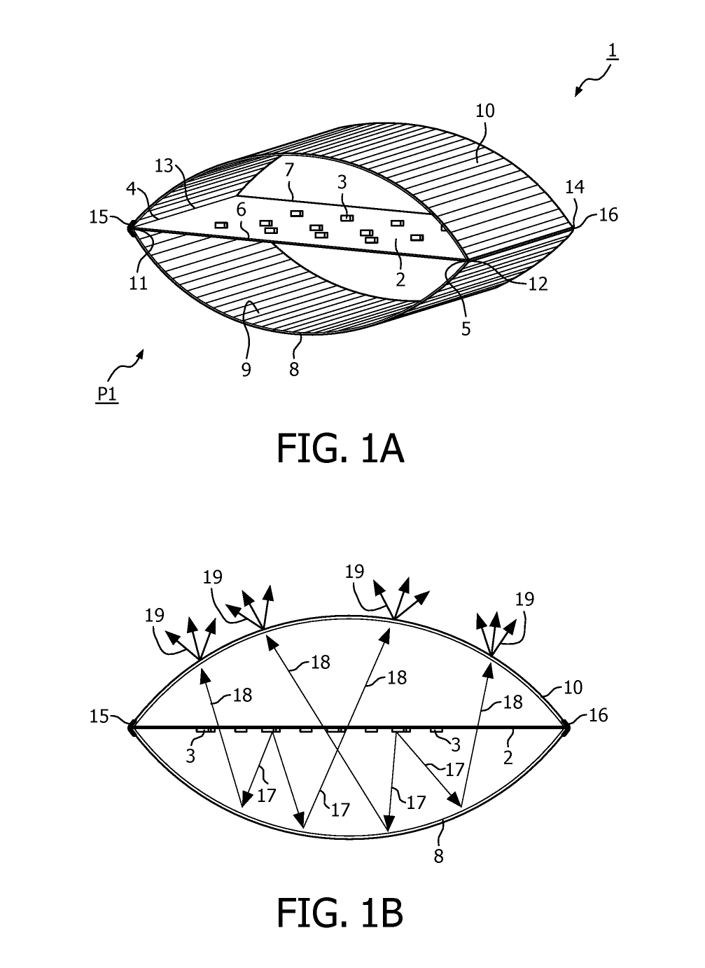

FIGS. 1A-3B show perspective and cross sectional views of a first embodiment of the lighting device 1 according to the invention. The lighting device 1 comprises a support panel 2 on which light emitting modules 3, for example LED's, are mounted on one side of the support panel 2. The support panel 2 has two opposite longitudinal sides 4, 5 and two opposite transverse sides 6, 7. The longitudinal sides 4, 5 extend in the direction of the arrow P1.

On the one side of the support panel 2 where the light emitting modules 3 are mounted, the lighting device 1 comprises a reflective outer sheet 8. The reflective outer sheet 8 is provided with a reflective layer 9. The reflective layer 9 is directed towards the light emitting modules 3. The reflective outer sheet 8 has a first and a second parallel longitudinal side 11, 12 which extend in the direction of the arrow P1. Preferably, the reflective outer sheet 8 is opaque, thus preventing light from being emitted from this side of the lighting device 1.

On the other side of the support panel 2 the lighting device 1 comprises a translucent outer sheet 10. The translucent outer sheet 10 has a first and a second parallel longitudinal side 13, 14 which extend in the direction of the arrow P1.

The first longitudinal side 11 of the reflective outer sheet 8 is connected to the first longitudinal side 13 of the translucent outer sheet 10 by means of a fastening means in the form of an adhesive tape 15. On the opposite side of both curved outer sheets, the second longitudinal side 12 of the reflective outer sheet 8 is connected to the second longitudinal side 14 of the translucent outer sheet 10 by means of a fastening means in the form of an adhesive tape 16.

In the unfolded position, as shown in FIGS. 1A and 1B, the outer sheets 8, 10 are spaced apart from each other and spaced apart from the support panel 2 between the interconnected first longitudinal sides 11, 13 and the interconnected second longitudinal sides 12, 14, thus forming a hollow, tube-like member that forms a housing of the lighting device 1.

In the unfolded position, the reflective outer sheet 8 and the translucent outer sheet 10 are curved in such a way that the interconnected first longitudinal sides 11, 13 and the interconnected second longitudinal sides 12, 14 are in contact with the longitudinal sides 4, 5 respectively of the support panel 2.

FIG. 1B shows the lighting device 1 in the unfolded position when in use. Light rays 17 are emitted by the light emitting module 3 towards the reflective outer sheet 8. These light rays 17 are reflected by the reflective outer sheet 8 as light rays 18 which pass through the at least partly translucent support panel 2 in the direction of the translucent outer sheet 10. The translucent outer sheet 10 acts as a diffuser. The light rays 18 that arrive at the translucent outer sheet 10 pass through the translucent outer sheet 10 as a multitude of light rays 19 travelling in a multitude of directions.

The diffusion of the light rays 18 reduces the intensity of the light. The light rays 19 that pass through the translucent outer sheet have an intensity that is far less than the intensity of the light rays 18. Glare, which is caused as a result of high intensity light rays, is therefore reduced to a great extent.

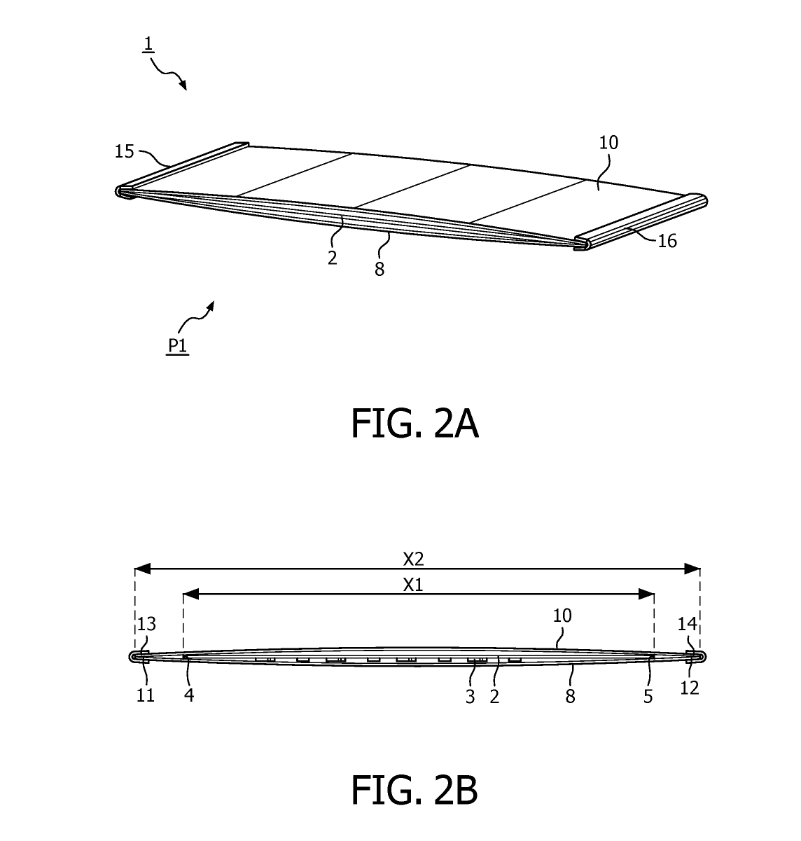

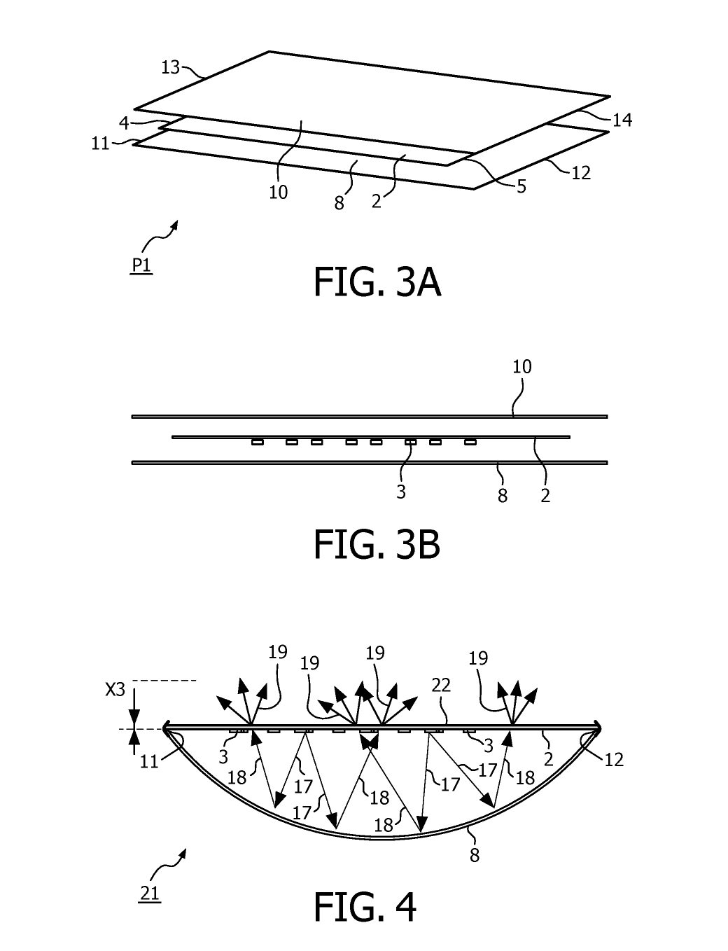

In the folded position of the lighting device, the support panel 2, the reflective outer sheet 8 and the translucent outer sheet 10 are all flat, as shown in FIGS. 2A-3B. The distance X1 between the longitudinal sides 4, 5 of the support panel 2 is smaller than the distance X2 between the longitudinal sides 11, 12 of the first outer sheet 8 and smaller than the same distance X2 between the longitudinal sides 13, 14 of the second outer sheet 10.

In the folded position of the lighting device, the reflective outer sheet 8 is adjacent to the light emitting modules, thus forming a protective layer for the light emitting modules 3, for example during storage and transport.

When converting the lighting device 1 from the folded into the unfolded position, a user can push the interconnected first longitudinal sides 11, 12 and the interconnected second longitudinal sides 13, 14 towards each other, thus reducing the distance between the connected longitudinal sides 11, 12 and 13, 14 with respect to each other. The distance between the interconnected first and second longitudinal sides 11, 12 and 13, 14 is reduced from distance X2 to distance X1. As the support panel 2 also has a distance X1 between the longitudinal sides 4, 5, the reduction of the distance X2 to X1 allows the support panel 2 to be held at the longitudinal sides 11, 12 and 13, 14 of the outer sheets.

When reducing the distance X2 to the distance Xl, the reflective outer sheet 8 and the translucent outer sheet 10 become curved in such a way that both outer sheets become spaced apart from each other and also become spaced apart from the support panel 2. To allow the curvature of the reflective outer sheet 8 and of translucent outer sheet 10, both outer sheets 8, 10 are made from a flexible material.

In the region of the adhesive tape 15, 16, the reflective outer sheet 8 and the translucent outer sheet 10 are adjacent to each other and tilted with respect to each other. The angle that is defined between the reflective outer sheet 8 and the translucent outer sheet 10 forms the space in which the support panel 2 is being kept. The support panel 2 can be tightly fitted between the longitudinal sides 11, 12 and 13, 14, thus being firmly mounted without any play in the transverse direction. The lighting device 1 can be maintained in the unfolded position by several means, for example by attaching the longitudinal sides 4, 5 of the support panel 2 to the interconnected longitudinal sides 11, 12, respectively.

The distance between adjacent light emitting modules 3 on the support panel 2 near the longitudinal sides 11, 12, 13, 14 is preferably smaller than the distance between adjacent light emitting modules 3 located near the middle of the support panel 2, so that throughout the lighting device the total length of a light path from the light emitting modules 3 on the support panel 2 towards the reflective outer sheet 8 and then back through the support panel 2 towards the translucent outer sheet 10 is slightly larger than the distance between adjacent light emitting modules 3 on the support panel 2.

FIG. 4 shows a second embodiment of the lighting device 21 according to the invention in the unfolded position.

Like the lighting device 1, the lighting device 21 comprises a support panel 2 with light emitting modules 3 in the form of light emitting diodes and a curved reflective outer sheet 8. The reflective outer sheet 8 faces the side of the support panel 2 on which the light emitting modules 3 are mounted.

On the opposite side of the support panel 2, the lighting device 21 comprises a flat translucent sheet 22 that acts as a diffuser and that is mounted on the support panel 2 at a distance X3.

In the folded, flat position of the embodiment of FIG. 4, the distance between the opposite longitudinal sides 4, 5 of the support panel 2 as well as the distance between the opposite longitudinal sides 13, 14 of the translucent outer sheet 10 is X1. The distance between the opposite longitudinal sides 11, 12 of the reflective outer sheet 8 is X2.

When converting this embodiment from the folded position into the unfolded position, the reflective outer sheet 8 becomes curved. The longitudinal sides 11, 12 of the reflective outer sheet 8 are connected to the longitudinal sides 4, 5 of the support panel 2. The distance X2 between the two opposite longitudinal sides 11, 12 is reduced to distance X1 to allow a connection of the curved reflective outer sheet 8 to the support panel 2.

The translucent outer sheet 22 is not curved with respect to the support panel 2. The translucent outer sheet 22 is mounted at a distance X3 from the support panel 2 to allow the light rays 18 to impinge on the translucent outer sheet 22 also above the light emitting modules 3. Dark spots caused by a shadow of the light emitting modules 3 are therefore prevented.

The distance X3 is preferably such that the total length of a light path from the light emitting modules 3 on the support panel 2 towards the reflective outer sheet 8 and then back through the support panel 2 towards the translucent outer sheet 22 is larger than the distance between adjacent light emitting modules 3 on the support panel 2.

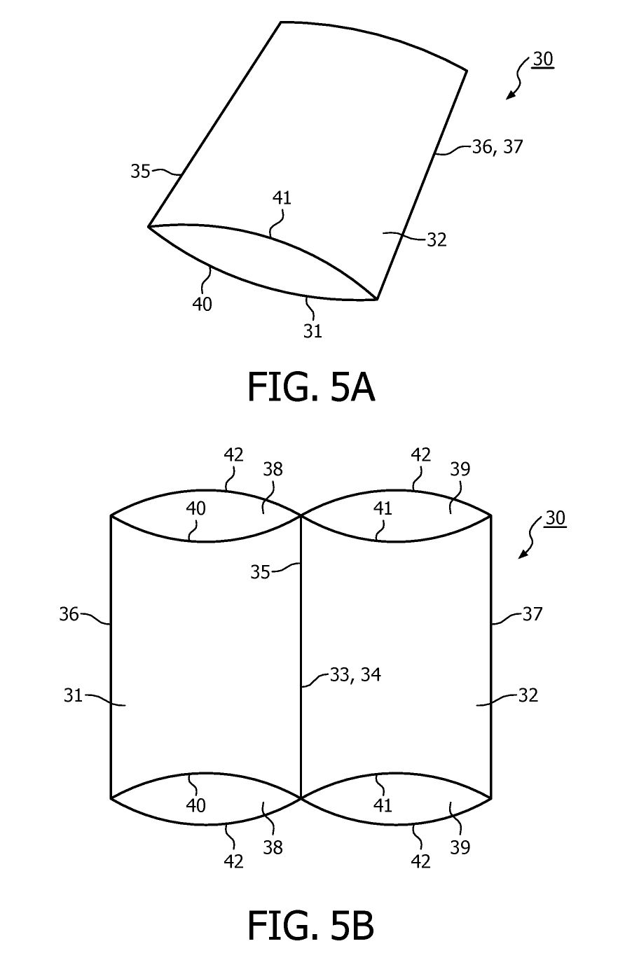

FIGS. 5A-5B show a lighting device 30 according to the invention in the unfolded position (FIG. 5A) and in the folded position (FIG. 5B).

The lighting device 30 comprises a support panel with light emitting modules (not shown), a reflective outer sheet 31 and a translucent sheet 32. In the folded position of the lighting device, as shown in FIG. 5B, the reflective outer sheet 31 and the translucent sheet 32 are connected to each other at longitudinal sides 33, 34 which forms a folding line 35. Longitudinal sides 36, 37 of the outer sheet 31, 32 are located on both sides of the folding line 35. In the folded position of the lighting device, both outer sheets 33, 34 are located in the same place.

On the transverse sides of the reflective outer sheet 31 and the translucent outer sheet 32, flaps are formed. The flaps 38, 39 are connected to the respective outer sheets 31, 32 via arc-shaped folding lines 40, 41. The arc-shaped folding lines 40 extend between the longitudinal sides 33, 36 of the reflective outer sheet 31. The folding lines 41 extend between the longitudinal sides 34, 37 of the translucent outer sheet 32. The arc-shaped folding lines 40, 41 are such that the convex side of the arc-shaped folding lines 40, 41 is located outside the flap 38, 39 and on the outer sheets 31, 32. The outer edge side 42 of the flaps 38, 39 that delimits the flaps 38, 39 on the side opposite to the arc-shaped folding lines 40, 41 has preferably the same arc-shaped form as the arc-shaped folding lines 40, 41. The concave side of the arc-shaped edge side 42 is directed towards the flaps 38, 39.

When converting the lighting device 30 from the folded to the unfolded position, the reflective outer sheet 31 and the translucent outer sheet 32 are folded around the folding line 35 in such a way that the longitudinal side 36 of the reflective outer sheet 31 and the longitudinal side 37 of the translucent outer sheet 32 become adjacent to each other. Both longitudinal sides 36, 37 are connected to each other by means of fastening means like tape. The connected longitudinal sides 33, 34 and the connected longitudinal sides 36, 37 are then moved towards each other, thus causing the outer sheets 31, 32 to curve in an arc-shaped form and to become at least partly spaced apart from each other. The outer sheets 31, 32 form a hollow, tube-like member. Subsequently, the flaps 38, 39 are folded around the arc-shaped folding lines 40, 41 through an angle of approximately 90 degrees, in order to cover an opening on the transverse side of the tube-like member.

Firstly, the flap 38 is folded around the folding line 40 until its edge side 42 is adjacent to the folding line 41 of the flap 39. Then the flap 39 is folded around the folding line 41 until its edge side 42 is adjacent to the folding line 40 of the flap 38. The folded flaps 38, 39 allow the lighting device 30 to be kept in the unfolded position so as to keep its constructional integrity. The flaps 38, 39 prevent the outer sheets 31, 32 from returning to the folded, flat position and ensure that the reflective outer sheet 31 and the translucent outer sheet 32 remain spaced apart.

Alternatively, also other means can be used to keep the reflective outer sheet 31 and the translucent outer sheet 32 spaced apart in the unfolded position. To this end, spacers, rods or flaps of any form can be used that are mounted in the transverse opening between the reflective outer sheet 31 and the translucent outer sheet 32.

The support panel 2 can be a wire grid or a stretched lead frame onto which light emitting modules are mounted.

The fastening means to connect the reflective outer sheet and the translucent outer sheet are not limited to adhesive tape. Other possible fastening means can for example be a glue, rings, buttons or a sewn thread.

Alternatively, the support panel 2 can be held between the outer sheets by other mounting means. To this end the longitudinal sides of the support panel 2 can be provided with protrusions, such as pins, that protrude into at least one of the outer sheets while holding the support panel in place. The other mounting means can also comprise folded cut-outs in the outer sheets that allow mounting of the support panel.

It is further noted that a lighting device can be provided wherein a light emitting module is mounted on the side of the support panel facing the translucent outer sheet.

Such a light emitting module on the side of the support panel facing the translucent outer sheet allows light of relatively high intensity to be distributed through the translucent outer sheet and towards the exterior of the lighting device.

The person skilled in the art will realize that the present invention is by no means limited to the preferred embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

### List of Reference Signs

1 lighting device
2 support panel
3 light emitting module
4 side
5 side
6 side
7 side
8 outer sheet
9 layer
10 outer sheet
11 side
12 side
13 side
14 side
15 tape
16 tape
17 light rays
18 light rays
19 light rays
21 lighting device
22 outer sheet
30 lighting device
31 outer sheet
32 outer sheet
33 side
34 side
35 folding line
36 side
37 side
38 flap
39 flap
40 folding line
41 folding line
42 edge side
P1 arrow
X1 distance
X2 distance
X3 distance

1. Lighting device comprising a support panel located between two outer sheets, which support panel is provided with at least one light emitting module (3), whilst at least one of the outer sheets is translucent, which outer sheets are movable with respect to each other at least from a folded position in which the support panel and the outer sheets extend substantially parallel to each other and an unfolded position in which the outer sheets are at least partly further spaced apart than in the folded position, wherein one of the outer sheets is reflective, whilst in the unfolded position light emitted by the light emitting module towards the reflective outer sheet is reflected by the reflective outer sheet towards the translucent outer sheet through the support panel,
wherein the outer sheets each have two parellel longitudinal sides, the parallel longitudinal sides of the reflective outer sheet and the respective parallel longitudinal sides of the translucent outer sheet being connectable to each other by fastening means,
at least one of the outer sheets comprises a flap being foldable around an arc-shaped folding line that extends between the two parallel longitudinal sides.

2. Lighting device according to claim 1, wherein the support panel is at least partly translucent.

3. Lighting device according to claim 1, wherein the translucent outer sheet is a light diffuser.

4. Lighting device according to claim 1, wherein, in the unfolded position, the outer sheets are curved.

5. Lighting device according to claim 1, wherein the reflective outer sheet is opaque.

6. (canceled)

7. Lighting device according to claim 1, wherein, in the unfolded position, the interconnected parallel longitudinal sides of the outer sheets comprise a mount for the support panel.

8. (canceled)

9. Lighting device according to claim 1, wherein a convex side of the arc-shaped folding line is located outside the flap.

10. Lighting device according to claim 9, wherein the flap is delimited by the arc-shaped folding line on one side of the flap and an arc-shaped edge on the opposite side of the flap.

11. Lighting device according to claim 1, wherein, in the unfolded position, the outer sheets are kept spaced apart by the folded flap.
